(19) United States
(12) Patent Application Publication
(10) Pub. No.: US 2023/0120761 A1
(43) Pub. Date: Apr. 20, 2023

(54) PROCESS SIGNAL RECONSTRUCTION AND ANOMALY DETECTION IN LASER MACHINING PROCESSES

(71) Applicant: Precitec GmbH & Co. KG, Gaggenau (DE)

(72) Inventors: Martin Krause, Graben-Neudorf (DE); Markus Thill, Gummersbach (DE); Fabian Mack, Karlsruhe (DE)

(21) Appl. No.: 18/047,859

(22) Filed: Oct. 19, 2022

(30) Foreign Application Priority Data
Oct. 19, 2021 (DE) 102021127016.2

(51) Int. Cl. B23K 26/03; B23K 31/12

(52) U.S. Cl. CPC B23K 26/03; B23K 31/125

(57) ABSTRACT

A method and a system for monitoring a laser machining process includes the steps of: inputting at least one process signal data set of the laser machining process into an autoencoder formed by a deep neural network; generating a reconstructed process signal data set by means of the autoencoder; determining a reconstruction error based on the at least one process signal data set and the at least one reconstructed process signal data set; and detecting an anomaly of the laser machining process based on the determined reconstruction error. A laser machining method includes the method and a laser machining system includes the system.

### CROSS-REFERENCE TO RELATED APPLICATIONS

This application claims priority to German Patent Application No. 10 2021 127 016.2, filed on Oct. 19, 2021, which is hereby incorporated by reference in its entirety.

### FIELD OF THE INVENTION

The present invention relates to a method for monitoring a laser machining process on a workpiece, in particular on a metal workpiece, a laser machining method, a system for monitoring a laser machining process, and a laser machining system for machining a workpiece using a laser beam with such a system.

### BACKGROUND OF THE INVENTION

In a laser machining process, a workpiece, in particular a metal workpiece, is machined using a machining laser. The machining may comprise, for example, laser cutting, laser soldering, laser welding and/or laser ablation. For example, the laser machining system may include a laser machining head.

Laser machining processes are often subject to quality control. In particular, when laser welding or soldering a workpiece, the quality of the machining result, i.e. the resulting joint, is examined. Current solutions for process monitoring and quality assessment in laser welding typically include a pre-, in- and post-process monitoring system. The pre-process system has the object of detecting the joint gap in order to guide the laser beam to the appropriate position and to determine the offset of the joint partners. In most cases, triangulation systems are used for this purpose. The in- and post-process systems are used to monitor the process and to ensure the quality of the resulting joint. In-process systems are also used to perform open-loop or closed-loop control of the laser process.

Post-process monitoring is often used for quality monitoring since the machining result of the laser machining process, for example a finished and cooled weld seam, may be examined and measured in accordance with applicable standards (e.g. SEL100). The post-process monitoring or post-inspection requires large effort in terms of system design. In many cases, a separate measuring cell has to be set up for post-process monitoring. In-process monitoring systems (also called in-line or on-line process monitoring systems) are typically designed to sense at least a portion of the radiation emitted by the laser machining process.

In-process processing is the processing of signals that are generated directly when the laser hits the workpiece to be machined. The signals may be acquired using photodiodes, line sensors, image sensors or multispectral or hyperspectral sensors. In each case, electromagnetic radiation emitted from the laser machining zone is used as a basis for data processing. The data may be integrated over a specific wavelength range with respect to time in a spatially resolved manner with image sensors and/or without spatial resolution with diodes and/or acquired with respect to time in a frequency-resolved manner with spectrometers. Other data, such as the laser power in the machining head, may also be used for data processing. Typically, the aim of such processing is the evaluation of the process.

Typical anomaly detection methods based on radiation intensity curves form reference curves from many acquired signal curves. Envelopes are formed around the reference curves. If a signal exceeds or falls below an envelope during the process, an error is triggered at previously defined error criteria. Criteria may be, for example, the integral of the signal above the envelope or the frequency with which the signal exceeds the envelope. This approach is based on the assumption that the process always remains the same. A laser material machining process under changing conditions may be difficult to monitor thereby. In addition, it is a lot of effort to parameterize signal changes that are not responsible for the quality.

In a subsequent step, the quality may be determined for samples by a worker through visual inspections or other measuring methods. Since material scientists make demands on a weld seam in terms of measurement values, a worker checks the weld seam on the workpiece by determining the required physical parameters, such as strength. The welded workpiece is subjected to a tensile test, for example, and the tensile force in Newton at which the weld seam breaks is determined. When welding contacts, for example, the conductivity in Siemens is determined since a specific conductivity of the welded structure is required. This subsequent step increases cycle times and is usually more expensive and complex than automated in-process monitoring and should therefore be avoided if possible. The quality characteristics determined by the worker for samples via visual inspections or other measuring methods may be documented using discretized or continuous values.

For in-process quality monitoring, a method based on these documented values and on learning methods with deep neural networks was also proposed. These methods learn an association of the incoming signal curves, images and/or control signals with a given quantity (a quality feature that can be easily interpreted) that is as general as possible. A regressor is used for continuous values and a classifier is used for discretized values. The learned association is then predicted by the in-process monitoring. Here, it's also possible to monitor a process with changing conditions since the generalized signal curve has been associated with a quality feature. In addition, it is easier to filter out signal changes that are not responsible for the quality.

EP 3 736 645 A1 describes a method for the automated control of material or laser machining processes. The method is controlled in closed loop by a controller that calculates correction output signals and controls an energy generation unit, an energy delivery unit, an energy delivery output measurement, and a material-energy interaction measurement unit to measure actual machining results. The actual machining results are fed to the controller. Generated correction output signals, which result in desired machining results, are supplied to the energy generation unit and the energy output unit via a controller output. The calculation of the correction output signals is performed by machine learning methods. The method includes storing time series of measurements, desired machining results and correction output signals in a memory of the controller, analyzing by comparison of the time series of the correction output signals and the time series of the measurements in an observation sub-unit based on a machine learning technique, and sending the correction output signals in the form of production conditions to the energy delivery control sub-unit and/or the second energy delivery control sub-unit.

DE 10 2018 129 441 A1 relates to monitoring of a laser machining process using deep convolutional neural networks and describes a system for monitoring a laser machining process for machining a workpiece, comprising: a computing unit configured to determine an input tensor based on current data from the laser machining process and to determine an output tensor containing information about a current machining result based on the input tensor by means of a transfer function, the transfer function between the input tensor and the output tensor being formed by a trained neural network.

### SUMMARY OF THE INVENTION

When the quality is monitored based on learning methods with deep neural networks, usually not all possible error types for a process can be learned. In addition, the user usually wants to monitor the quality with as few error examples as possible. The behavior of a classifier or regressor in the case of unknown error types or extrapolations is often unpredictable. The results may deviate significantly from the expected prediction and lead to misinterpretations. In the case of a regression, for example, large extrapolations may result in blatant outliers (processes/products that would actually be “not OK”) being rated with a similar value to actual good welds (processes/products “OK”). In addition, the result of a regression or classification using deep neural networks can only be explained with additional methods, which are usually complex in the evaluation. Without the additional methods, the user cannot see how the decision of the algorithm came about.

It is an object of the invention to provide a method for monitoring a laser machining process with a neural network, said method allowing to detect when an anomaly of the laser machining process occurs and requiring as few instances of faulty machining for training the neural network as possible.

It is a further object of the invention to provide a method for monitoring a laser machining process using a neural network, said method allowing a quality feature of the laser machining process to be determined and the plausibility of the determined quality feature to be checked in addition. In this context, it is desirable to use the plausibility check to obtain additional confidence in the correctness of the determination of the quality feature even if faulty machining or error types occur that were not considered when the neural network was trained. In particular, it is desirable that as few examples of incorrect machining as possible are required for training the neural network.

One or more of these objects are achieved by the features disclosed herein.

According to an aspect of the present disclosure, a method for monitoring a laser machining process is provided, the method comprising the steps of: inputting at least one process signal data set of the laser machining process into an autoencoder formed by a deep neural network; generating a reconstructed process signal data set by means of the autoencoder; determining a reconstruction error based on the at least one process signal data set and the at least one reconstructed process signal data set; and detecting an anomaly of the laser machining process based on the determined reconstruction error. The input process signal data set may also be viewed as the input layer, the reconstructed process signal data set as the output layer. Thus, for example, the input layer or the incoming process signal data set is mapped to a coding and the coding in turn is mapped to the output layer or to the reconstructed process signal data set.

According to a another aspect of the present disclosure, a method for monitoring a laser machining process is provided, the method comprising the steps of: inputting at least one process signal data set of the laser machining process into an autoencoder formed by a deep neural network; generating an encoding by means of the autoencoder; generating a reconstructed process signal data set by means of the autoencoder; determining a reconstruction error based on the at least one process signal data set and the at least one reconstructed process signal data set; determining a degree of abnormality based on the Mahalanobis distance and/or a weighted sum of individual characteristic values of the reconstruction error; and detecting an anomaly of the laser machining process based on the determined degree of abnormality. Thus, detecting an anomaly of the laser machining process may be performed based on the determined degree of abnormality. In turn, the degree of abnormality may be determined based on the reconstruction error. The degree of abnormality may also be referred to as an anomaly score or measure of abnormality.

One or more of the aspects mentioned may include one or more of the features described below.

The laser machining process may comprise laser cutting, soldering, welding and/or ablation, for example. The autoencoder is formed in particular by a trained (learned) deep neural network. The neural network may be trained by error feedback or backpropagation. Here and below, a neural network is understood to mean an artificial neural network.

The process signal data set may also be referred to as a sensor data set. The reconstructed process signal data set may also be referred to as a reconstructed sensor data set. The process signal data set input into the autoencoder may be referred to as the process signal input data set. The reconstructed process signal data set generated by the autoencoder may be referred to as the process signal output data set.

Generating a reconstructed process signal data set by means of the autoencoder may also be referred to as reconstructing a process signal data set by means of the autoencoder. That is, the method may comprise: reconstructing the (input) process signal data set by generating a reconstructed process signal data set by means of the autoencoder. The method may comprise the step of: generating an encoding by means of the autoencoder, in particular based on the input at least one process signal data set of the laser machining process. The autoencoder may generate a reconstructed process signal data set based on the generated encoding. The autoencoder may include an encoder and a decoder. The at least one process signal data set of the laser machining process may be input into the encoder. Based on the input at least one process signal data set of the laser machining process, the encoder may generate an encoding. The reconstructed process signal data set may be generated by the decoder. The decoder may generate the reconstructed process signal data set (reconstruct a process signal data set) from the generated encoding. The encoding may also be referred to as a latent feature space (“latent space”), compressed mapping or dimensional reduction or bottleneck (“bottle neck”).

The incoming process signal data set and the reconstructed process signal data set may have the same dimension and size (number of components per dimension). For example, they may have a dimension N, each with kn elements, where N, kn are natural numbers, with n=1, . . . , N. In particular, the process signal data set (or process signal input data set) input into the autoencoder may be input into the autoencoder in the form of a tensor and the reconstructed process signal data set generated by the autoencoder (process signal output data set) may be generated in the form of a tensor, the input process signal data set and the reconstructed process signal data set being tensors of identical dimension and size. Thus, although a dimensional reduction takes place within the autoencoder, the reconstructed process signal data set has the same dimension and size as the process signal data set input into the autoencoder. The term tensor includes a vector (1-dimensional tensor). The respective tensor spaces in which the process signal input data set and the process signal output data set are defined may be identical. The generation of a reconstructed process signal data set by means of the autoencoder may thus comprise in particular: mapping the process signal input data set as a reconstructed process signal output data set in the form of a tensor with identical dimension and size (identical tensor space). This may be referred to as mapping “onto itself”. The autoencoder may be called a machine learning algorithm autoencoder.

The signals or the process signal data set may be reconstructed by means of dimension reduction via a deep autoencoder. The reconstruction error may determine whether an anomaly is present or whether a regression and/or classification result is valid. A special feature is that during the laser machining process to be monitored and/or afterwards, an anomaly of the process may be detected based on the determined reconstruction error.

The processing of the process signals (or the process signal data set) using an autoencoder for anomaly detection may be described as follows. In an embodiment, the autoencoder performs the following processing: The encoder, consisting of a deep neural network, extracts features from incoming signals into an encoding. At the same time, said encoding represents a dimension reduction of the incoming process signals. This allows for the process signals to be described in a few dimensions. The decoder, consisting of a deep neural network, reconstructs the process signals.

Thus, the present invention is directed at anomaly detection using deep neural networks and a plausibility check or verification of a regression and/or classification result when monitoring a laser material machining process, as well as quality assessment of the products. The invention is based on the idea of obtaining a reconstructed process signal data set from the processing of a process signal data set by an autoencoder and of examining whether the reconstructed process signal data set matches the original process signal data set input into the autoencoder. If this is the case, it can be assumed that the autoencoder processes the key features of the process signal data set in the expected manner and the laser machining process thus corresponds to what was taken into account when the autoencoder was created or trained (taught). However, when the reconstruction error indicates that the reconstructed process signal data set does not match the original process signal data set input into the autoencoder, an anomaly in the laser machining process may be detected. It may then be concluded that the laser machining process does not correspond to what was taken into account when creating or training the autoencoder.

When the data is sufficiently compressed, the at least one process signal data set (i.e. the input signal) can only be reconstructed correctly if the autoencoder has been trained with this data in advance. When learning the data, the weights of the autoencoder may be adjusted in a plurality of epochs by means of backpropagation until the reconstruction error is minimal. Here, the reconstruction error may be the mean absolute or squared deviation of the process signal data set (i.e. the input signal) from the reconstructed process signal data set (i.e. reconstructed signal). The reconstruction error may be the signed, absolute or squared deviation summed or integrated along the time axis. For example, when training with a plurality of data sets, the autoencoder learns to encode recurring features and patterns and to decode them again. For a known laser machining process, the measured process signals can be perfectly reconstructed with a well-trained autoencoder, except for signal noise, even when there are fluctuations in the process signal. Only the fluctuations in the process signal that also occurred in the learned signals are perfectly reconstructed. The structure of the autoencoder determines how well the features and patterns can be abstracted and generalized. When anomalies occur, e.g. in the form of gross differences in the signal curve from the previously learned signal curves, these are not correctly reconstructed by the autoencoder. Therefore, the reconstruction error for unknown laser machining processes, such as those that occur with quality defects, is significantly larger than for known laser machining processes.

The method according to the invention may be carried out continuously and/or repeatedly while the laser machining process is being carried out.

A process signal data set of the laser machining process is to be understood as a data set of at least one process signal of the laser machining process. Process signals for the laser machining process may be measured or acquired. A process signal data set may include, for example, a time series of a process signal, for example measured intensities over a time interval, and/or may include a measured process parameter of the laser machining process. In particular in in-process monitoring systems, a process signal data set may include raw data in order to be able to carry out an analysis or evaluation in real time particularly quickly and efficiently.

Process signals may, for example, be acquired or measured with one or more sensors, for example may be recorded or acquired or measured with at least one of at least one photodiode, at least one line sensor, at least one image sensor, at least one camera, at least one triangulation sensor, at least one sensor for optical coherence tomography (OCT), at least one acoustic sensor and/or at least one multispectral or hyperspectral sensor. A process signal of the laser machining process may include, for example: process radiation/emission of the laser machining process, such as thermal radiation and/or plasma radiation, an image of the workpiece surface of a workpiece, radiation intensity of the laser machining process reflected at the workpiece, a process signal from the laser machining head, such as a scattered radiation intensity of scattered radiation inside the laser machining head or a temperature of an element inside the laser machining head. A process signal may be measured, for example, in optical coherence tomography by radiating measuring light and detecting the reflected measuring light. Electromagnetic radiation emitted from the laser process zone may also be measured as a process signal and used as a process signal data set as a basis for monitoring a laser machining process. The electromagnetic radiation may include, for example, process emissions such as thermal radiation, plasma radiation and/or reflected laser radiation from a surface of a workpiece. However, the process signals may also include acoustic signals.

Process signals may also include control signals used by a control for the laser machining process, e.g. laser power, machining speed, etc.

The reconstruction error preferably describes a deviation of the at least one reconstructed process signal data set from the at least one process signal data set input into the autoencoder. The reconstruction error may include a mean absolute or squared deviation, for example. The reconstruction error may be calculated using different criteria. For example, in the case of sequential time series, the reconstruction error may only be used for certain signal ranges. It is also possible to consider the reconstruction error separately for individual dimensions (if these are not uniformly normalized, for example) and to estimate a covariance matrix and a mean value vector, for example. The reconstruction error may be determined based on a metric, for example. Metrics such as the Mahalanobis distance may be used as a measure of the degree of abnormality (or as a measure of the reconstruction error). In addition, a reconstruction error may also be calculated using FFT or wavelets (continuous CWT and/or discrete DWT) for different frequency ranges.

The method may include: determining a degree of abnormality, wherein detecting an anomaly of the laser machining process is performed based on the determined degree of abnormality. In particular, a degree of abnormality may be determined based on a weighted summation or on the Mahalanobis distance with respect to individual characteristic values for the reconstruction error.

The method may include: determining a degree of abnormality, particularly based on the reconstruction error; and detecting an anomaly of the laser machining process based on the determined degree of abnormality. In particular, the step of detecting an anomaly of the laser machining process based on the determined reconstruction error may include: determining a degree of abnormality based on the reconstruction error; and detecting an anomaly of the laser machining process based on the determined degree of abnormality.

The step of determining a reconstruction error may include: determining a Mahalanobis distance, in particular based on the at least one process signal data set and the at least one reconstructed process signal data set.

Determining a degree of abnormality may include: determining a degree of abnormality based on the Mahalanobis distance and/or a weighted sum of individual characteristic values of the reconstruction error.

Determining a degree of abnormality may include: determining a Mahalanobis distance, in particular based on the at least one process signal data set and the at least one reconstructed process signal data set.

The step of determining the Mahalanobis distance may be carried out with respect to:
the deviation of the at least one process signal data set (sensor data set) from the at least one reconstructed process signal data set (sensor data set); and/or
individual characteristic values of the reconstruction error; and/or
the encoding of a process signal data set (sensor data set).

Characteristic values for the reconstruction error may include and/or be referred to as characteristic values for the reconstruction error/characteristic values of the reconstruction error, characteristic numbers for the reconstruction error/characteristic numbers of the reconstruction error, parameters for the reconstruction error/parameters of the reconstruction error, feature(s) for the reconstruction error/feature(s) of the reconstruction error, and/or a metric for the reconstruction error/metric of the reconstruction error.

The method may comprise or the step of determining a reconstruction error may comprise: determining the parameters mean value vector and covariance matrix of the Mahalanobis distance, in particular determining the parameters mean vector and covariance matrix of the Mahalanobis distance using defect-free or labeled data sets.

The method may comprise: determining a degree of abnormality based on the weighted summation and/or on the Mahalanobis distance with respect to individual characteristic values, in particular with respect to the individual characteristic values for the reconstruction error. The weighted summation may be the signed, absolute or squared deviation summed or integrated along the time axis.

The method may comprise: setting a limit value which distinguishes between standard and anomaly on the basis of the degree of abnormality. For example, in the step of detecting an anomaly, an anomaly of the laser machining process may be detected based on whether the degree of abnormality reaches and/or exceeds the limit value.

Detecting an anomaly of the laser machining process based on the determined reconstruction error may also be referred to as detecting whether there is an anomaly in the laser machining process based on the determined reconstruction error. Detecting an anomaly of the laser machining process based on the determined reconstruction error may mean or comprise determining based on the determined reconstruction error that either there is an anomaly of the laser machining process or there is not an anomaly of the laser machining process. For example, a criterion (assessment criterion) used for the reconstruction error or the measure thereof may determine or define whether there is an anomaly of the laser machining process. The reconstruction error decides whether it is an anomaly. For example, detecting an anomaly of the laser machining process may include: detecting an anomaly of the laser machining process based on a measure of the determined reconstruction error.

Detecting an anomaly of the laser machining process may comprise, for example: detecting/recognizing that there is an anomaly in the laser machining process when the determined reconstruction error meets an error criterion, e.g. the reconstruction error exceeds a threshold value or a measure of the reconstruction error exceeds a threshold value. Assuming that information about the laser machining process is contained in the process signal data set, a small reconstruction error indicates that the autoencoder has encoded relevant features of the laser machining process. However, when the reconstruction error is large in relation thereto, this in turn indicates an anomaly and thus features of the laser machining process that were not sufficiently acquired by the autoencoder.

The method may comprise: classifying the at least one process signal data set as an anomaly or as a normal case based on the determined reconstruction error. For example, the at least one process signal data set may be classified as an anomaly when the presence of an anomaly in the laser machining process is detected based on the determined reconstruction error.

The method may comprise: classifying the laser machining process or (in particular) a machining result of the laser machining process as “OK” or “not OK” based at least on whether, in the step of detecting an anomaly of the laser machining process, an anomaly of the laser machining process is recognized. For example, in the case that an anomaly in the laser machining process is detected, the laser machining process or a product of the laser machining process may be classified as “not OK”. The machining result may be a product of the laser machining process, for example. Classifying the laser machining process may in particular include classifying a machining result of the laser machining process.

When the method is used for quality inspection in the laser machining process, anomalies indicate a quality defect or a faulty process, and the product is classified as “not OK” when the reconstruction error exceeds a threshold value. The autoencoder is then usually only trained with signals (process signal data sets) for a laser machining process the product or process of which has been classified as “OK”.

The method preferably comprises: measuring at least some of the process signals of the process signal data set, and/or transmitting (or transferring) at least some of the process signals of the process signal data set from a control.

At least some of the process signals may be acquired or measured with one or more sensors, for example, as described above. In particular, the control may be a control that controls the laser machining process. The controller may be, for example, a controller for a laser machining system for machining a workpiece using a laser beam. Process signals transmitted by a control may, for example, include control signals, e.g. a specified laser power, a target focal position, a machining speed, etc.

The method may comprise: inputting one or more process conditions of the laser machining process into the autoencoder. Process conditions may include, e.g., workpiece material, machining configuration, weld geometry (e.g., lap weld, butt weld, etc).

The method for monitoring a laser machining may comprise, for example, a pre-process monitoring method, an in-process monitoring method and/or a post-process monitoring method. With an in-process monitoring method, monitoring during workpiece machining may be enabled.

In particular when laser welding or soldering a workpiece, it is important to check or assess and/or ensure the quality of the joint created. One object is to reliably locate and detect all defects.

In embodiments, the method further comprises the steps of: determining a quality feature of the laser machining process; and evaluating the quality feature as valid when no anomaly is detected in the step of detecting an anomaly of the laser machining process; and evaluating the determined quality feature as not valid when an anomaly is detected in the step of detecting an anomaly of the laser machining process.

The method may therefore provide an application of an anomaly detector which preferably includes or consists of an autoencoder with a deep neural network and which reconstructs process signals (a process signal data set), with a reconstruction error being used for the evaluation. The quality feature is thus validated depending on whether no anomaly is detected in the step of detecting an anomaly of the laser machining process. The method thus makes it possible to determine a quality feature of the laser machining process and also to check the plausibility of the determined quality feature. In particular, not only can errors be detected or, for example, a machining result of the laser machining process can be classified as “not OK” based on the quality feature, but cases in which an anomaly is detected and the quality feature is therefore to be regarded as not valid can also be caught. Especially in the field of laser material machining, there is usually not enough data available for quality monitoring with deep neural networks. In laser material machining in particular, it is desirable to ensure process monitoring when the process conditions change. It is therefore particularly advantageous for the user that quality monitoring can be implemented in this way with as few examples of incorrectly machined materials as possible.

The quality feature may in particular be a predictive value. Determining a quality feature of the laser machining process may be a prediction of the quality feature of the laser machining process. The quality feature may describe a prediction for a quality of the laser machining process or (in particular) of the machining result of the laser machining process. For example, it may characterize a machining quality or any machining errors. The expression “prediction for a quality of the laser machining process” may in particular include a prediction for a quality of the machining result of the laser machining process.

Two cases should be mentioned here in particular: The quality feature may be determined from discrete values or from continuous values. That is, the quality feature may be determined from a range of values that includes discrete (or discretized) values (e.g., discrete classification values) or may be determined from a range of values that includes a continuous range of values.

The quality feature may comprise a physical quality feature, for example a prediction for a physical quantity (physical property, physical value) of the laser machining process or of the machining result of the laser machining process. For this purpose, the quality feature may in particular be determined from continuous values. In a laser welding process, the physical variable may be, for example, the strength/tensile strength of a weld seam, the electrical conductivity of the welded structure, or the smoothness of the weld seam. For example, during the ongoing laser machining process, the control parameters of the process may be influenced by means of the determined quality feature. Thus, the laser machining process may be controlled. The quality feature may, for example, characterize the machined workpiece.

The quality feature may, for example, classify a quality of the laser machining process or of the machining result of the laser machining process. Therefrom, it can be inferred whether the machining process leads to the desired criteria of the machining process or the workpiece, or whether machining errors occur. For this purpose, the quality feature may in particular be determined from discrete values. For example, a classification may be “OK”/“error-free” or “not OK”/“faulty” (i.e. there is an error). For example, the workpiece may be marked or classified as “OK”/“good” (i.e. suitable for further processing or sale) or as “not OK”/“poor” (i.e. as scrap). The quality feature may, for example, include a prediction that there is an error. In the case of a laser welding method, for example, the quality feature may include a prediction that a gap is present. The determination of the at least one quality feature and in particular the detection of machining errors may be carried out automatically, and thus process monitoring, in particular online process monitoring, may become possible.

A quality feature of the laser machining process may be determined based on the at least one process signal data set of the laser machining process. Significant features are extracted or calculated from the at least one process signal data set, for example as a quality feature for the quality of the laser machining process. In a laser welding process or laser soldering process, for example, these may represent or describe the quality of the welded and soldered seams.

Determining a quality feature of the laser machining process may include determining a quality feature of the laser machining process using a regressor or a classifier that is formed by a (trained) neural network. Preferably, a regressor is used for continuous values and a classifier for discrete (e.g. discretized) values. The autoencoder and the regressor or classifier may be formed as separate algorithms. The autoencoder and the regressor or classifier may be arranged in parallel. The autoencoder and the regressor or classifier may receive the at least one process signal data set via a common input layer. Alternatively, the regressor or classifier may be arranged in parallel with a decoder of the autoencoder. In this case, the regressor or classifier may be arranged downstream of an encoder of the autoencoder and may receive the encoding therefrom (so-called extended autoencoder).

Determining the quality feature may be performed in real time. Based thereon, closed-loop and/or open-loop control data may be output to a laser machining system carrying out the laser machining. The value of a physical property and/or a classification may thus be used for closed-loop control of the laser machining process, in particular when the respective value is determined while the laser machining process is being carried out. A closed-loop control of the laser machining process may include an adjustment of a focal position, a focus diameter of the laser beam, a laser power and/or a distance of a laser machining head.

In embodiments of the method, in the step of determining a quality feature of the laser machining process, a value for the quality feature is determined by a regressor formed by a neural network; and/or in the step of determining a quality feature of the laser machining process, a classification value for the quality feature is determined by a classifier formed by a neural network.

The quality feature determined by the regressor or classifier is thus evaluated as valid or not valid depending on whether an anomaly is detected in the step of detecting an anomaly of the laser machining process. A plausibility check of the regressor or classifier may thus be carried out. In particular, the regressor or classifier may be formed by a deep neural network. A classification value may also be determined based on a physical quantity.

A plausibility check and verification of the regressor or classifier may thus be carried out using the reconstructed signals. The validity of the prediction (i.e. the quality feature) may be checked. The reconstruction error determines whether there is an anomaly or whether the regression and/or classification result is valid. A regression and/or classification for determining a quality feature of a laser machining process is thus combined with a plausibility check and anomaly detection using a deep neural network. In laser material machining in particular, there is usually not enough data available for quality monitoring with deep neural networks for regression and classification. It is therefore particularly advantageous for the user that quality monitoring can be realized in this way with as few examples of incorrectly machined materials as possible. The behavior of a classifier or regressor in the case of unknown error types or extrapolations is often unpredictable. Such cases may be covered by evaluating the specific quality feature as “not valid”.

Anomaly detection using reconstruction errors may mask the predicted value of the regressor or classifier (the quality feature). A product may be classified as “not OK” regardless of the predicted value when an anomaly is detected, for example when the reconstruction error exceeds a threshold value. When the reconstruction error is below the threshold value, the result of the predicted value of the regressor or classifier may be accepted as valid. In this way, the autoencoder may also be trained with signals for a laser machining process the process/product of which was classified as “not OK”. In addition, the regressor allows for association with a physical quality feature and the classifier allows for association with a discrete error pattern.

Preferably, the autoencoder is trained together with the regressor and/or classifier using known data. The autoencoder may be trained either as a separate algorithm in parallel with the regressor or classifier or as an extended autoencoder including the regressor or classifier as a unified algorithm. The autoencoder and the regressor or classifier may be trained as follows: The data are labeled with a discrete or continuous value. This value represents a quality feature. With an extended autoencoder, a common encoding that represents recurring features and patterns may then be created. For the quality monitoring of laser machining processes, the quality feature may then be predicted, for example from this encoding, using the regressor or classifier and the signals (the at least one process signal data set) may be reconstructed via the decoder in parallel or at the same time. A plausibility check and verification of the regressor or classifier may then be carried out using the reconstructed signals.

Assuming that the information is contained in the signal curve, a small reconstruction error indicates that the predicted quality feature is valid. However, when the reconstruction error is large in relation thereto, this may in turn indicate an anomaly and thus an invalid predicted quality feature as well as a quality defect or faulty process. The user sees when certain signals or signal areas are not predicted well and may initiate a check or retraining of the algorithm.

An anomaly may in turn be checked using other methods, either by visual inspection of the worker or other measuring methods, and associated with a quality feature. In the case of the plausibility check of regressor or classifier, an extended autoencoder or regressor or classifier with the autoencoder may also be trained with this new labeled data set.

In embodiments, the autoencoder and at least one of the regressor and the classifier have a common encoder; and/or the regressor and/or the classifier determines the quality feature based on data from an encoder of the autoencoder.

The determination of the quality feature is thus based on processing of the at least one process signal data set by means of the encoder of the autoencoder or the common encoder. At least one of the regressor and the classifier may determine the quality feature based on an encoding generated by the encoder or data from the encoder. As a result, a close relationship between the determined quality feature and the reconstructed process signal data set is established. Therefore, by detecting an anomaly, it is recognized with a high level of certainty whether the determined quality feature is valid. The encoder may thus be a common part of a neural network which comprises the autoencoder and the at least one of the regressor and the classifier. It is also advantageous that the regressor or the classifier can process dimensionally reduced data from the autoencoder. When the deep autoencoder and at least one of the regressor and the classifier have a common encoder, the autoencoder may also be an extended autoencoder comprising the at least one of the regressor and the classifier, in particular an extended deep autoencoder. The extended autoencoder may be trained as a unified algorithm comprising the regressor and/or classifier.

In other embodiments, the autoencoder and at least one of the regressor and the classifier are parallel to each other; and/or the regressor and/or the classifier determines the quality feature based on the at least one process signal data set; and/or the autoencoder and at least one of the regressor and the classifier have a common input layer.

The autoencoder and at least one of the regressor and the classifier form separate algorithms in this case. In particular, they may comprise separate neural networks, wherein the neural network of the autoencoder and the neural network of the at least one of the regressor and the classifier may have a common input layer. The autoencoder may be trained as a separate algorithm in parallel with the regressor and/or the classifier.

The autoencoder and at least one of the regressor and the classifier are preferably trained with the same data. As a result, a close relationship between the determined quality feature and the reconstructed process signal data set is established. The validation of the quality feature may thus be improved by the step of detecting the anomaly.

The step of determining a reconstruction error may include: determining a deviation of the at least one process signal data set from the at least one reconstructed process signal data set. The step of determining a reconstruction error may include: determining a mean absolute or squared deviation of the at least one process signal data set from the at least one reconstructed process signal data set, in particular determining a signed, absolute or squared deviation summed up along the time axis.

The step of determining a reconstruction error may include: filtering at least part of the process signal data set and/or the reconstructed process signal data set; and determining the reconstruction error based thereon.

The filtering may include, for example, filtering to reduce noise, for example filtering through a noise filter. In order to minimize the influence of unsystematic signal noise, the signals may be filtered to form the reconstruction error.

The reconstruction error may be determined, for example, as the determined deviation or based on the determined deviation. The deviation may, for example, be averaged, subjected to the formation of the absolute value, and/or squared. The reconstruction error may be determined, for example, as a mean absolute or squared deviation.

The method may comprise: normalizing the reconstruction error with respect to the process signal data set. The normalization of the reconstruction error using the input signal level serves to improve the comparability of the reconstruction error and may therefore simplify the detection of an anomaly.

Both in the case of anomaly detection and in the case of the plausibility check of regressor or classifier, an autoencoder reconstructs the incoming data, i.e. the at least one process signal data set, and a reconstruction error is determined from a difference between the input signal and the reconstruction signal. If current measurements have not been learned, the reconstruction error becomes large. A large reconstruction error indicates an anomaly, which in turn may represent a quality defect. In the case of anomaly detection only, the autoencoder may only be trained with training data in the form of signals (or corresponding process signal data sets) for laser machining processes the product or process of which has been classified as “OK” or “good”. In the case of a plausibility check of regressor or classifier, the autoencoder may be trained together with these and with all input signals of the quality monitoring system of the laser machining processes they have been trained on. These are preferably essentially examples that have been checked and provided with a quality feature. In the case of a plausibility check of the regressor or classifier, training data on laser machining processes the product or process of which has been classified as “OK” or “good” and training data on laser machining processes the product or process of which has been classified as “not OK” or “bad” may be used for training. In the case of a plausibility check of regressor or classifier, the autoencoder may be trained either as a separate algorithm in parallel or as an extended autoencoder as a unified algorithm. In the case of a plausibility check of regressor or classifier, for example, an anomaly may be checked, associated with a quality feature and additionally learned by the regressor or classifier and autoencoder or extended autoencoder.

In embodiments, the neural network of the autoencoder and/or the regressor and/or the classifier is adjustable. This allows for transfer learning. The trained neural network may be adjustable using training data through transfer learning. In particular, the neural network may be adjustable to new process signal data sets or new laser machining processes that have been newly labeled with a quality feature, for example. An adjustable neural network that can be (re)trained using training data through transfer learning is particularly flexible, versatile and user-friendly.

A neural network may be retrained using transfer learning, for example when an anomaly is detected. A physical variable may be measured or classified by experts to specify a quality feature using the machined workpiece and, if necessary, using destructive techniques.

The use of a trained neural network configured for transfer learning therefore has the advantage that the method can be quickly adjusted to changed situations, in particular to a changed laser machining process. The occurrence of anomalies can thereby be reduced. For example, a valid quality feature may be determined for a plurality of or different laser machining processes.

According to a further aspect of the present disclosure, a laser machining method is provided, said laser machining method comprising the steps of: machining a workpiece using a laser beam; and monitoring the laser machining process according to the method of monitoring a laser machining process.

Machining of a workpiece by means of the laser beam may also be referred to as carrying out the laser machining process or may be included therein. Machining of a workpiece by means of the laser beam can comprise, for example, laser cutting, soldering, welding and/or ablation.

The laser machining method may further comprise: measuring process signals of the laser machining process, and/or transmitting process signals from a control; wherein monitoring the laser machining process comprises: inputting at least one process signal data set of the laser machining process into the autoencoder, the process signal data set comprising the measured process signals and/or the process signals transmitted by a control.

According to a further aspect of the present disclosure, a system for monitoring a laser machining process is provided, said system comprising: at least one sensor unit (e.g. a sensor assembly) configured to measure process signals of the laser machining process; at least one autoencoder formed by a deep neural network; and at least one computing unit (e.g. a processor) configured to execute the method for monitoring the laser machining process. At least one process signal data set of the process signals of the laser machining process is input into the autoencoder.

According to a further aspect of the present disclosure, a laser machining system for machining a workpiece by means of a machining laser beam is provided, said laser machining system comprising: a laser machining head for radiating the machining laser beam onto the workpiece; and the system for monitoring a laser machining process. The laser machining system may be configured to carry out the laser machining method described. The computing unit may be configured to closed-loop and/or open-loop control the laser machining process on the basis of closed-loop control data and/or open-loop control data.

The system and the laser machining system for machining a workpiece may realize all the advantages that also apply to the method and in particular to one of the embodiments of the method.

### BRIEF DESCRIPTION OF THE DRAWINGS

Embodiments of the present invention are described in detail below with reference to figures. The figures depict various features of embodiments, the features not being limited only to the embodiments. Rather, all features that are not mutually exclusive may also be combined with one another or features may be removed from embodiments if they are not essential for the implementation of the invention.

FIG. 1 shows a schematic diagram of a laser machining system for machining a workpiece by means of a laser beam and a system for monitoring a laser machining process according to an embodiment;

FIG. 2 shows a schematic diagram of a deep autoencoder for processing process signal data sets of the laser machining process according to an embodiment;

FIG. 3 schematically shows a process signal data set and a reconstructed process signal data set;

FIG. 4 schematically shows a process signal data set and a reconstructed process signal data set in case of an anomaly in the laser machining process;

FIG. 5 shows a schematic diagram of a deep autoencoder in parallel with a regressor or classifier according to an embodiment;

FIG. 6 shows a schematic diagram of an extended deep autoencoder together with a regressor or classifier according to an embodiment; and

FIG. 7 shows a schematic diagram of a method for monitoring a laser machining process according to an embodiment.

### DETAILED DESCRIPTION OF THE INVENTION

Unless otherwise noted, the same reference symbols are used below for the same elements and those with the same effect.

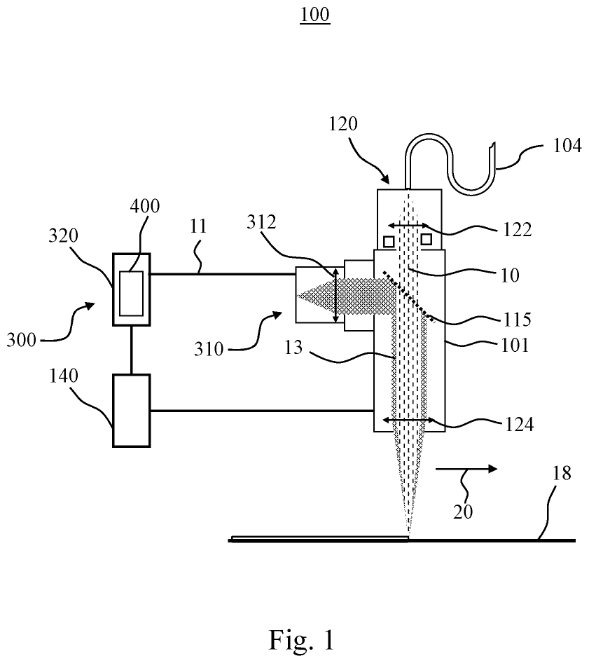

FIG. 1 shows a schematic diagram of a laser machining system 100 for machining a workpiece by means of a laser beam 10 according to embodiments of the present disclosure. The laser machining system 100 comprises a laser machining head 101, in particular a laser cutting, laser soldering or laser welding head, and a system 300 for monitoring the laser machining process including a sensor unit or sensor assembly 310 as an example of a laser machining head according to one embodiment. The system 300 for monitoring the laser machining process further comprises a computing unit or processor 320.

The laser beam 10 is supplied, for example, via an optical fiber 104 from a laser source (not shown). The beam path of the (machining) laser beam 10 extends via collimation optics 122 and focusing optics 124 onto a workpiece 18 being machined.

According to embodiments, the laser machining system 100 or parts thereof, such as the machining head 101, may be movable relative to the workpiece 18 along a machining direction 20. The machining direction 20 may be a cutting, soldering or welding direction and/or a direction of movement of the laser machining system 100, such as the machining head 101, with respect to the workpiece 18. In particular, the machining direction 20 may be a horizontal direction.

The laser machining system 100 is controlled by a controller 140 configured to control the machining head 101.

Process emissions 13 occur during machining, for example thermal radiation, plasma radiation and/or laser radiation reflected from a surface of a workpiece. A portion of the process emissions 13 is guided at least partially coaxially or collinearly to the beam path of the machining beam 10 from the surface of the workpiece via a beam splitter 115 and collimator optics 312 to the sensor unit 310.

The computing unit 320 includes a deep neural network in the form of a deep autoencoder 400 and receives from the sensor unit 310 process signals 11 which are input into the neural network 400 in the form of process signal data sets 30.

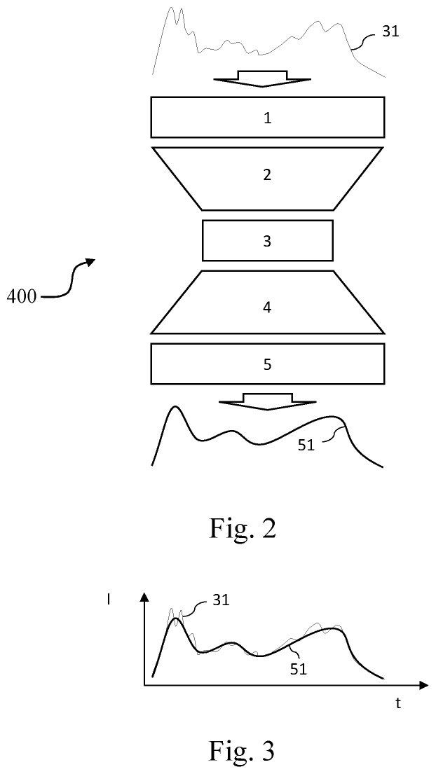

FIG. 2 shows a schematic diagram of the deep autoencoder 400 for processing process signal data sets 31 of the process signals 11 of the laser machining process. The autoencoder 400 includes an input layer 1, an encoder 2, a coding layer 3, a decoder 4 and an output layer 5. The coding layer 3 is a common layer of the encoder 2 and the decoder 4.

The autoencoder 400 performs the following processing: At least one process signal data set 31 of a process signal 11 is input into the input layer 1. The encoder 2, consisting of a deep neural network, extracts features of incoming signals 11 into an encoding in a coding layer 3. This encoding also represents a dimension reduction of the incoming process signals 11. This enables the process signals 11 to be described in a few dimensions. The decoder 4, consisting of a deep neural network, reconstructs the process signals. A reconstructed process signal data set 51 of the reconstructed signal is output at the output layer 5.

FIG. 3 schematically shows a process signal data set 31 and an associated reconstructed process signal data set 51, for example as a course of a signal intensity I over time t. Except for signal noise, fluctuations in the process signal 11 that also occurred in the signals learned by the autoencoder 400 are almost perfectly reconstructed.

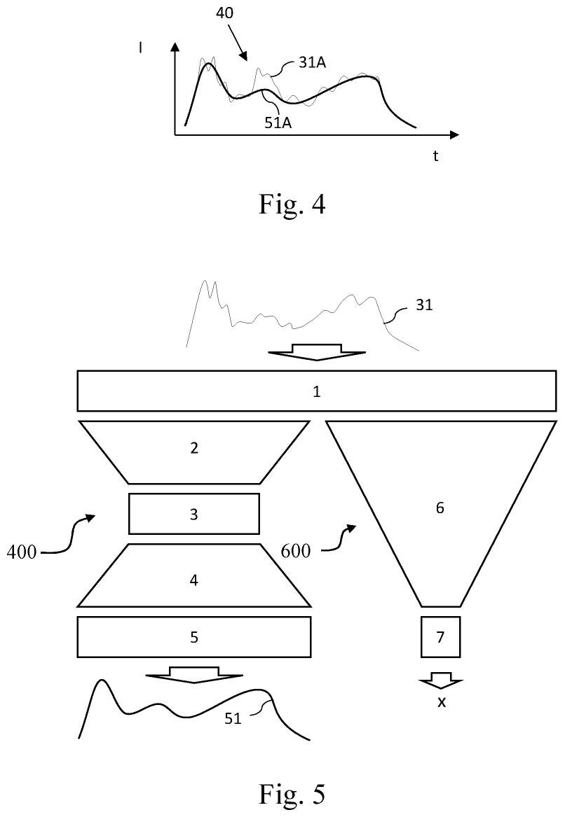

FIG. 4 schematically shows a process signal data set 31A and an associated reconstructed process signal data set 51A in case an anomaly 40 occurs in the laser machining process. When anomalies 40 occur in the form of gross differences in the signal curve compared to the previously trained signal curves, these are not correctly reconstructed by the autoencoder 400.

The computing unit 320 determines a reconstruction error as the mean absolute or squared deviation of the input signal 11 or process signal data set 31/31A from the reconstructed signal or reconstructed process signal data set 51/51A.

When the reconstruction error exceeds a threshold value, the computing unit 320 detects the presence of an anomaly 40. When the method is used directly for quality assessment in the laser machining process, the anomalies 40 indicate a quality defect or faulty process, and the product is classified by the computing unit 320 as “not OK” when an anomaly 40 was detected, i.e. when the reconstruction error exceeds a threshold value.

Some of the process signals of the process signal data set 31 may also be transmitted by the controller 140. Process signals transmitted by the controller 140 may include, for example, control signals, e.g. a specified laser power, a target focal position, a machining speed, etc. Corresponding reconstructed process signals are then part of the reconstructed process signals of the reconstructed process signal data set 51.

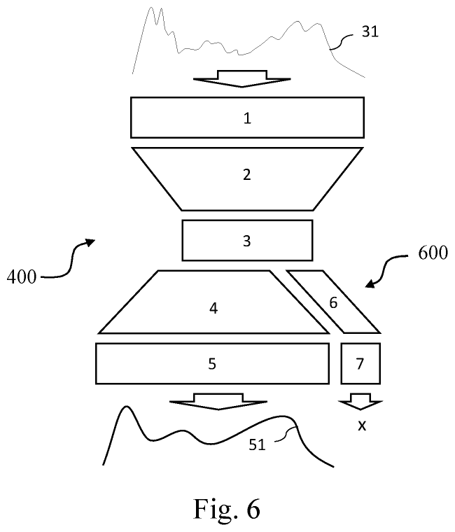

FIGS. 5 and 6 show schematic diagrams of the deep autoencoder 400 together with a regressor 600 or classifier 600 for predicting a quality feature x of the laser machining process. In the quality monitoring of the laser machining process, the quality feature x of the laser machining process is predicted, the quality feature x is assessed as valid when no anomaly 40 is detected, and the quality feature x is assessed as invalid when an anomaly 40 is detected.

The autoencoder 400 is trained together with the regressor 600 or classifier 600 with known data. For this purpose, the data are labeled with a discrete or continuous value that represents the quality feature x. The regressor 600 or classifier 600 is implemented as a deep neural network 6 with an output layer 7 in the computing unit 320.

FIG. 5 shows a schematic diagram of a deep autoencoder 400 in parallel with a regressor 600 or classifier 600.

At least one process data set 31 is input into the common input layer 1 of the autoencoder 400 and the regressor 600 or classifier 600 for the quality monitoring of laser machining processes. Therefrom, the quality feature x is predicted by means of the deep neural network 6 of the regressor 600 or classifier 600, and at the same time the process signals are reconstructed as a process signal data set 51 via the autoencoder 400.

FIG. 6 shows a schematic diagram of an extended deep autoencoder 400 that includes a regressor or classifier 600.

The extended autoencoder 400 creates a common encoding, which represents recurring features and patterns, in the coding layer 3. For quality monitoring of laser machining processes, the quality feature x is predicted from the encoding of the coding layer 3 by means of the deep neural network 6 of the regressor 600 or classifier 600, and at the same time the process signals are reconstructed from the encoding of the coding layer 3 as a process signal data set 51 via the decoder 4.

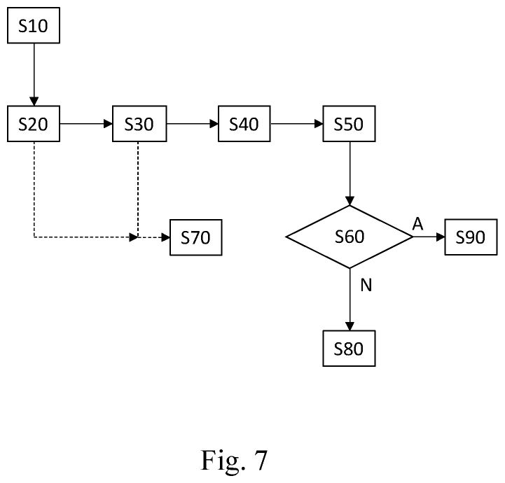

FIG. 7 shows a schematic diagram of an exemplary method for monitoring a laser machining process, such as may be carried out by the system 300 according to FIG. 4 or 5.

The method includes the following steps:

Step 510: measuring at least some of the process signals of the process signal data set 31 and/or transmitting at least some of the process signals of the process signal data set 31 from the control 140;

Step S20: inputting the process signal data set 31 of the laser machining process into the autoencoder 400;

Step S30: generating an encoding by means of the encoder 2;

Step S40: generating of a reconstructed process signal data set 51 by means of the autoencoder 400;

Step S50: determining a reconstruction error by means of the computing unit 320;

Step S60: detecting an anomaly of the laser machining process by means of the computing unit 320 based on the determined reconstruction error;

Step S70: determining a value of a quality feature of the laser machining process, for example by means of the regressor 600 or classifier 600;

Step S80: evaluating the quality feature as valid when no anomaly is detected in step S60 (case N); and

Step S90: evaluating the quality feature as not valid when an anomaly is detected in step S60 (case A).

As described for the exemplary embodiments, a plausibility check and anomaly detection in combination with deep neural networks for regression and classification in laser material machining is made possible by an extended autoencoder. Based on the autoencoder, the signals may be reconstructed and a reconstruction error may be calculated. The reconstruction error may be used both to evaluate the quality of the laser machining process and to check the validity of the prediction of the regressor or classifier.

The initial effort when generating error examples in laser material machining for training quality monitoring systems based on a regressor or classifier can thus be significantly reduced since their availability space can be limited according to the known error examples. The user can monitor the quality with a few error examples and a few good examples. The prediction accuracy for the quality of the process and the product can be increased during the ongoing production process by the worker analyzing anomalies, providing them with a quality feature and the proposed algorithm or method, i.e. the autoencoder and, if necessary, the regressor and/or classifier, re-learning them.

1. A method for monitoring a laser machining process, said method comprising the steps of:
inputting at least one process signal data set of the laser machining process into an autoencoder formed by a deep neural network;
generating a reconstructed process signal data set by means of said autoencoder;
determining a reconstruction error based on the at least one process signal data set and the at least one reconstructed process signal data set; and
detecting an anomaly of the laser machining process based on the determined reconstruction error.

2. The method according to claim 1, further comprising:
measuring at least some of the process signals of the process signal data set;
and/or
transmitting at least some of the process signals of the process signal data set from a control.

3. The method according to claim 1, further comprising the steps:
determining a quality feature of the laser machining process; and
evaluating the quality feature as valid when no anomaly is detected in the step of detecting an anomaly of the laser machining process; and
evaluating the determined quality feature as not valid when an anomaly of the laser machining process is detected in the step of detecting an anomaly.

4. The method according to claim 3, wherein:
the step of determining a quality feature of the laser machining process is by means of a regressor formed by a neural network, and a value for the quality feature is determined;
and/or
the step of determining a quality feature of the laser machining process is by means of a classifier formed by a neural network, and a classification value for the quality feature is determined.

5. The method according to claim, wherein:
said autoencoder and at least one of said regressor and said classifier have a common encoder;
and/or
said regressor and/or said classifier determines the quality feature based on data from an encoder of said autoencoder.

6. The method according to claim 4, wherein:
said autoencoder and at least one of said regressor and said classifier are parallel to each other;
and/or
said regressor and/or said classifier determines the quality feature based on the at least one process signal data set;
and/or
said autoencoder and at least one of said regressor and said classifier have a common input layer.

7. The method according to claim 4, wherein said autoencoder and at least one of said regressor and said classifier are trained with the same data.

8. The method according to claim 1, wherein the step of determining a reconstruction error comprises:
determining a deviation of the at least one process signal data set from the at least one reconstructed process signal data set;
and/or
determining a mean absolute or squared deviation of the at least one process signal data set from the at least one reconstructed process signal data set;
and/or
determining a signed, absolute or squared deviation summed up along the time axis;
and/or
determining a Mahalanobis distance.

9. The method according to claim 1, wherein the step of determining a reconstruction error comprises determining a Mahalanobis distance with respect to:
a deviation of the at least one process signal data set from the at least one reconstructed process signal data set;
and/or
individual characteristic values of the reconstruction error;
and/or
encoding of a process signal data set.

10. The method of claim 8, wherein said method comprises determining parameters mean vector and covariance matrix of the Mahalanobis distance using defect-free or labeled data sets.

11. The method according to claim 1, wherein the reconstruction error for individual dimensions is determined separately and/or based on a metric and/or by means of a fast Fourier transformation and/or a wavelet transformation.

12. The method according to claim 1, wherein:
said method comprises normalizing the reconstruction error with respect to the process signal data set;
and/or
the step of determining a reconstruction error comprises:
filtering at least part of the process signal data set and/or the reconstructed process signal data set; and
based thereon, determining the reconstruction error.

13. The method according to claim 1, wherein said method comprises:
determining a degree of abnormality;
wherein detecting an anomaly of the laser machining process is based on the determined degree of abnormality.

14. The method according to claim 13, wherein the determining a degree of abnormality is based on a weighted summation or on a Mahalanobis distance with respect to individual characteristic values for the reconstruction error.

15. A laser machining method, comprising the steps of:
machining a workpiece by means of a laser beam; and
monitoring the laser machining process according to the method according to claim 1.

16. A system for monitoring a laser machining process, said system comprising:
at least one sensor assembly configured to sense process signals of the laser machining process;
at least one autoencoder formed by a deep neural network; and
at least one processor configured to carry out the method for monitoring the laser machining process according to claim 1.

17. A laser machining system for machining a workpiece by means of a machining laser beam, said laser machining system comprising:
a laser machining head for radiating the machining laser beam onto said workpiece; and
a system according to claim 16.
